(19) United States
(12) Patent Application Publication
(10) Pub. No.: US 2011/0057623 A1
(43) Pub. Date: Mar. 10, 2011

(54) SYNERGISTIC SYSTEM BETWEEN BATTERY CHARGER AND BATTERY

(75) Inventor: Federico Vitali, Monterubbiano (IT)

(73) Assignee: FAAM S.P.A., Monterubbiano (AP) (IT)

(21) Appl. No.: 12/991,358

(22) PCT Filed: May 22, 2009
(86) PCT No.: PCT/EP2009/003646

§ 371 Date: Nov. 5, 2010

(30) Foreign Application Priority Data
May 27, 2008 (IT) MC2008A000094

(51) Int. Cl. H02J 7/04

(52) U.S. Cl. 320/145; 320/162

(57) ABSTRACT

A synergistic system made up of a control unit having the function of identifying and monitoring the battery, and transmitting the information regarding the actual state of its energy conditions to a battery charger, made to attain energy saving and well as a greater functionality and efficiency of the identified battery.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention concerns a synergistic system made up of a control unit having the function of identifying and monitoring the battery, and transmitting the information regarding the actual state of its energy conditions to a battery charger, made to attain energy savings and well as a greater functionality and efficiency of the identified battery.

2. Description of Related Art Including Information Disclosed Under 37 CFR 1.97 and 37 CFR 1.98.

When charging a battery, traditional battery chargers absorb energy from the mains and transfer it to the battery converting the input alternating voltage into direct voltage of suitable value.

The overall efficiency of a battery charge cycle depends on three factors made up of the electric efficiency factor, the battery charger power factor and the charge factor.

The electric efficiency factor is determined by the percentage ratio between the power supplied to the battery and the power supplied from the mains and by the amount of power that is dissipated inside the battery charger in form of heat, thus implying that the higher the electric efficiency the higher the efficiency of the entire system.

The power factor of a battery charger depends on the ratio between the actual power effectively used by the battery charger and the apparent power absorbed from the mains. Alongside the actual power, the battery charger absorbs—from the mains—also another type of power, referred to as reactive power which, at each input voltage cycle, is temporarily stored in the battery charger and then returned to the mains, hence said energy is not used for charging the battery.

The power factor is determined by the displacement factor and by the distortion factor whose values may vary between 0 and 1 and, the more said values coincide, the lower the power factor which is the cause of some problems when charging, among which: application of penalties by the electric power provider when the overall power factor does not reach a minimum preset value, usually set between 0.90 and 0.95; power increase in the line considering the same amount of power actually absorbed by the battery charger.

The charge factor is given by the ratio between the amount of energy (ampere hour) required to charge a battery—such energy being required to be higher than the capacity—and the amount of energy discharged from the battery. During the final charging phase, the voltage of the battery is at maximum and thus there is a high dispersion of energy hence it is necessary to shorten said phase protecting the gasification principle required to remix the electrolyte so as to avoid stratification thereof. Current battery chargers are provided with low-frequency transformers which determine a low power factor, around 0.85%, which usually leads to an increase of the current in the line considering the same actual power employed and it causes many secondary problems that considerably jeopardize the overall efficiency of the battery charger and of the battery itself.

Equally troublesome are chargers with low frequency transformers controlled with SCR (Silicon Controlled Rectifiers) due to the fact that their power factor is very low, around 0.70% leading to high displacement caused by their transformers and by a strong distortion of the current caused by the SCR. High frequency battery chargers of the switching type are also currently available, but their power factor does not exceed 0.85% due to a high distortion of the current determined by their input though they are not subjected to a considerable displacement.

According to the current state of the art there are no battery chargers that can be used only for batteries provided with an identification and monitoring module in such a way to adapt the charge cycle to their effective efficiency and operation conditions, automatically adjusting and compensating for any supply power voltage variations during the final charging phase, in such a way to reduce consumption of energy, heat and, hence, the thermal stress of the same identified battery.

The above is confirmed by the patent applications mentioned below which, though describing and claiming a system capable of keeping the battery charge temperature constant, do not anticipate the inventive concept of the present application which, alongside overcoming said drawback in a novel way, describes and claims an integrated system for identifying and monitoring the battery, in such a way to adapt the functions of the battery charger to the conditions of maintenance and efficiency of the battery saving energy during charging thereof.

Thus, the patent having the title “Method for charging traction storage battery”, Publication No. RU2312432 dated Oct. 12, 2007, solely describes and claims a method for charging traction storage batteries which constantly monitors the temperature of the electrolyte inside the battery.

The European patent having the title “Method and charger for recharging power batteries, such as traction batteries”, Publication No. WO2007042594 dated 19 Apr. 2007, claims a system for identifying and monitoring the temperature of a battery being charged, not taking into account some energy saving references as claimed in the present application.

The European patent having the title “Method for optimizing the cycle life of traction batteries”, Publication No. EP 1648048 dated 19 Apr. 2006, claims a system for checking the voltage and the temperature for automobile batteries, with a technical method different from the object of the present application and without any claim regarding the charge cycles.

The German patent “Accumulator battery charging system for traction battery periodically reduces charging voltage during main charging phase and applies sawtooth pulsed voltage during final phase”, Publication No. DE20221450 dated 19 Jan. 2006, solely describes and claims a system that maintains the internal temperature of the battery low, based on a pulsed charge with few and brief pauses in the first phase for charging the battery and, in the second phase, a charge with sawtooth periodic of the charge voltage without reaching its complete annulment. The method concerning adapting the charge to the state of the battery and the energy saving of the charge as described and claimed in the present application is absolutely not described and claimed in the abovementioned patent.

The patents having the title “Lead acid charger” published with No. WO9624979 on 15 Aug. 1996 and “Lead acid charger with ratioed time-out periods and current pulse mode of operation” published with No. U.S. Pat. No. 5,670,863 on 23 Sep. 1997 are the most similar to the technical method claimed by the present application, deferring in that said patents (especially the first one) describe and claim a control method in PWM and not a traditional battery charger complete with a transformer, rectifier etc. In addition, said patents neither describe or claim the module for identifying and monitoring the battery nor energy saving solutions as described and claimed in the present application.

Lastly, the patent having the title “Battery charging” published with No. U.S. Pat. No. 4,234,839 on 18 Nov. 1980 solely describes and claims a method for transmitting data between the battery charger and the battery solely for checking temperature.

### BRIEF SUMMARY OF THE INVENTION

An object of the present invention is that of overcoming the abovementioned drawbacks by providing the users with a synergistic system made up of a battery characterised by an identification module and by a battery charger which, due to their technical characteristics claimed in the present application, allow the battery charger, upon receiving the battery identification data through the identification and monitoring module, to adapt the power and energy factors to the operation parameters of the identified battery in such a way to maximise the electric efficiency and functionality of the entire charge cycle.

Another object of the present invention is that of adjusting the final charge ratio automatically compensating any voltage and power supply variations in such a way to reduce heat so as to eliminate the identified battery stress to increase its efficiency, though protecting the gasification phase.

Another object of the present invention is that of obtaining a system for a battery charger suitable to be used solely for batteries identifiable by the control unit through a password and are produced by the filing company in such a way to increase their energy efficiency and extend the duration of their efficiency.

Another object of the present invention is that of providing a system for charging batteries capable of eliminating or at least reducing the energy consumptions required with an optimal electric efficiency of 92-93% due to the fact that it is capable of guaranteeing a high power factor and eliminate energy dispersions that usually occur in traditional battery chargers.

These and other objects are attained by the invention subject of the present application concerning a synergistic system made up of a battery characterised by an identification and monitoring module provided with a digital memory bearing the battery identification and operation data, such as the voltage, current, temperature and level of equalisation which, each time the battery is connected for charging, are transmitted to the battery charger and used by a system of technical solutions interacting with each other in such a way to adapt the charge cycle to the actual conditions of the identified battery hence attaining the maximum energy efficiency during the entire charge cycle, including the final one, self-regulating and self-compensating any power supply voltage variations in such a way to reduce the heat that is usually formed in the final charge phase with the further effects of increasing the efficiency of the same identified battery and considerably reducing the energy consumption of the entire charge cycle.

Another object of the present invention is that of allowing the charging of the batteries at lower costs and with greater technical characteristics with respect to the battery charging systems known today and increasing the energy efficiency of the batteries of the filing company which can be provided with the identification and monitoring module whose actuation requires a password, alongside being characterised by an anti-tampering and block mechanism.

### BRIEF DESCRIPTION OF THE SEVERAL VIEWS OF THE DRAWINGS

FIG. 1 is a diagram showing connection of the battery components to the charger of the present invention.

### DETAILED DESCRIPTION OF THE INVENTION

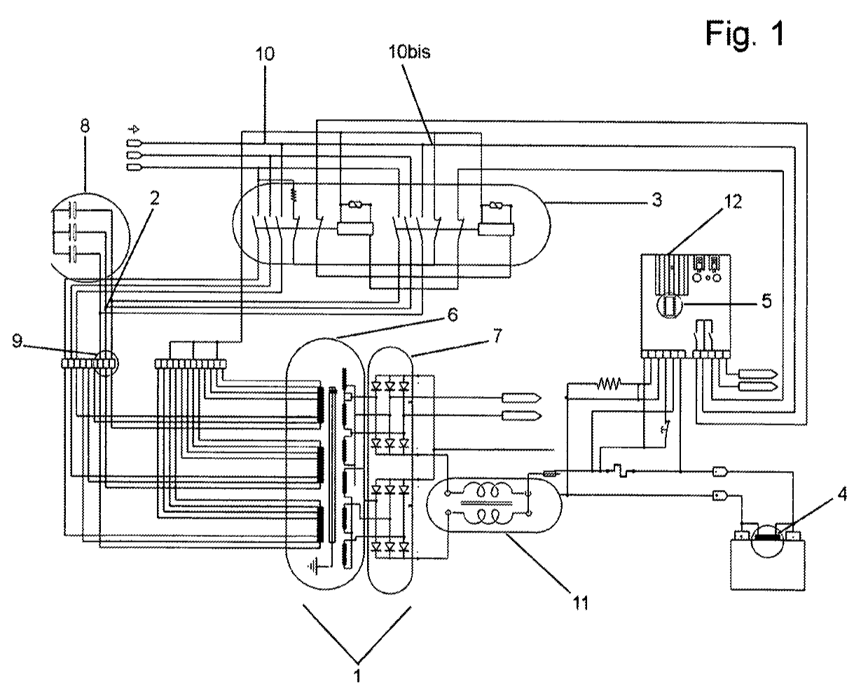

Further characteristics and advantages of the invention shall be apparent from the description of a preferred but not exclusive embodiment of the present application, illustrated for indication purposes in the sole drawing attached (FIG. 1) showing an electrical diagram for connecting the battery components to the charger subject of the present invention made up of four technical solutions necessarily interacting with each other to attain a better energy efficiency and reduce the energy costs of the entire charge cycle.

Said technical solutions are: a 12 pulse frequency multiplication system (1) serving to raise the distortion factor to 0.99;the system for static power factor correction with capacitors (2) serving to raise the displacement factor to 0.99, or to the same value as the distortion factor in such a way to guarantee the battery charging system a high power factor; the pulse end-of-charge system (3) which, interacting with the identification and monitoring module (4) and its microprocessor (5), compensates any power supply voltage variations, including the final charging phase, automatically adjusting them to the parameters of the battery being charged regarding the voltage, current, temperature and level of equalisation, in such a way to have a considerable reduction of energy consumption and a greater dispersion of heat required to eliminate the battery stress in order to increase energy efficiency and duration thereof.

The functionality of the present invention is based on the required integratability of the aforementioned systems which are in turn provided with an equal number of technical elements required for their operation. Thus the 12 pulse frequency multiplying system (1) is provided with a three-phase transformer (6) with nine coils, with flow dispersed through partial overlapping of layers, and with a double full-wave three-phase rectifier bridge (7).

An optional component of the multiplying system (1) is the interphase reactance (11) which has the purpose of leveling the currents that circulate on the rectifier bridges in such a way to reduce the temperature of the operation and filter the current supplied by the battery charger in such a way to render it perfectly direct.

Said element can be omitted in the system in case the battery charger transformer is perfectly symmetric. The static power factor correction system with capacitors (2) is provided with a three-phase static power factor correction bank (8) connected on the transformer primary with fixed capacity (9) and the capacitors can be three or multiples of three and they can be star-connected or triangle-connected.

The pulse end-of-charge system (3) is characterised by a double input contactor (10) and (10bis) which allows varying the transformation ratio of the transformer by automatically adjusting the end-of-charge current pulses, the pause time of each pulse and the total number of pulses to be used on the technical parameters of the battery being charged transmitted by the microprocessor (5).

Said microprocessor (5) which interacts with the identification and monitoring module (4) and which is inserted in a sealed container (12) so as to protect it against corrosion of the acid, water and vibrations, is an electrical circuit serving to memorise and transmit all battery functional and maintenance parameters to the technical solutions system with which the battery charger is provided each time the latter is connected to the battery. The identification module (4) is installed on the battery when it is put to service and it can be activated solely by means of a password at the first connection of the battery charger.

More in particular, in order to adapt the charge curve to the battery operation parameters, the battery charger subject of the present application may operate on two different power levels identifiable as low power and high power. The low power is used at the beginning of the charge until the battery reaches a preset voltage value, after which the charge continues through high power charge pulses interrupted by pauses varied by the battery charger depending on the parameters read by the microprocessor (5) being capable of passing from high power pulses to low power pulses or vice versa and also being capable of interrupting the pulses to protect the battery in case of excessive temperature.

In this case, given the possibility that the battery be damaged by thermal leakage, the microprocessor (5) sends pre-alarm signals indicating the values of the measured temperature, in such a way that the battery charger interrupts the previously calculated high power pulse beforehand or replaces it with a low power pulse.

Malfunctions that occur during the various charge phases of the same battery are memorised by the battery charger in such a way to avoid, during the subsequent operations to charge the same battery, the reoccurrence of the malfunctions observed in the previous charge cycles.

Furthermore, the identification module (4) is provided with a block and anti-tampering system, and it is supplied with power from the same battery. The identification module communicates with the control card of the battery charger using the POWER LINE COMMUNICATION system, by overlapping a high frequency signal directly onto the battery power cables in such a way to avoid the addition of supplementary connection cables.

When the identification module is installed onto the battery, it activates the power line communication system, but remains blocked, awaiting activation. Upon first connection to the battery charger, the module is identified and, through the battery charger control panel, it can be activated by entering a password.

Once activated, the module does not require further operations and operates continuously as along as it is connected to the battery. If disconnected, even temporarily, it returns to the blocked status, hence it shall require the activation process, protected through a password, during the subsequent connection to the battery charger.

The patent thus conceived is susceptible to various modifications and variants, all falling within the concept of the invention; furthermore the materials and the elements of the invention as described and illustrated in the attached drawing claimed hereinafter, may vary depending on the requirements.

1. Synergistic system between battery charger and battery made for identifying and monitoring the operation data of the battery to be charged so as to reduce energy consumption and obtain greater functionality and efficiency of the charge cycle and of the battery identified characterised by an identification and monitoring module interacting with a microprocessor used to memorise all operation and maintenance parameters of the battery: such as voltage, current, temperature and level of equalisation which, each time the battery is connected to the battery charger, are connected to a technical solution system of the battery charger subject of the present patent application which, interacting with each other, adapt the charge cycle to the actual efficiency and maintenance state of the identified battery hence ensuring maximum energy efficiency over the entire charge cycle, including the final one, automatically adjusting and automatically compensating any power supply voltage variations in such a way to reduce the heat that is normally generated in the final charging phase leading to further increasing the efficiency of the same identified battery and considerably reducing the energy consumption of the entire charge cycle.

2. Synergistic system between battery charger and battery according to claim 1 wherein said identification and monitoring module installed on the battery is characterised by a microprocessor inserted into a sealed container in such a way to resist against acid corrosion, against water and vibrations and it is made up of an electrical circuit used to memorise and transmit all the operation parameters to a technical solution system which, interacting with each other, adapt the charge circuit to the actual efficiency and maintenance condition of the identified battery ensuring maximum energy efficiency and good maintenance thereof.

3. Synergistic system between battery charger and battery according to claim 1, characterised in that the identification and monitoring module with the microprocessor also serve to prevent the battery from being damaged by thermal leakage sending a pre-alarm signal with the value of the measured temperature, in such a way that the battery charger interrupts the previously calculated high power pulse beforehand or provides for the replacement thereof with a low power pulse and also memorises the malfunctions that might have occurred during the various charge phases of the same battery in such a way to avoid, during the subsequent charging operations on the same battery, the reoccurrence of the malfunctions observed in the previous charge cycles.

4. Synergistic system between battery charger and battery according to claim 1, characterised in that the identification and monitoring module is supplied with power directly by the battery and exploits the power line communication technology in such a way to avoid the addition of supplementary cables.

5. Synergistic system between battery charger and battery according to claim 1, whose identification and monitoring module is characterised by a password for the activation thereof and by a block and anti-tempering system.

6. Synergistic system between battery charger and battery according to claim 1, characterised by a set of battery charger technical solutions made up of a twelve-pulse frequency multiplying system, a static power factor correction system with capacitors, a pulse end-of-charge system which, interacting with each other and with the identification and monitoring module and the microprocessor, compensate any power supply voltage variations, including the final charge phase, automatically regulating them to the parameters of the battery being charged regarding voltage, current, temperature and level of equalisation, in such a way to have a considerable reduction of energy consumption and greater heat dispersion required to eliminate the battery stress in such a way to increase the energy efficiency and duration thereof.

7. Synergistic system between battery charger and battery according to claim 1, whose twelve-pulse frequency multiplying system and static power factor correction system are characterised in that they respectively raise the distortion and power factor correction factors to a coinciding value of 0.99 in such a way to allow the power factor required to obtain the maximum energy efficiency of the charge cycle.

8. Synergistic system between battery charger and battery according to claim 1, whose final charge system, interacting with the identification and monitoring module of the battery and the microprocessor, is characterised in that it compensates any power supply voltage variations automatically adjusting them to the efficiency and maintenance parameters of the battery being charged, said parameters being made up of voltage, current, temperature and level of equalisation in such a way to reduce the energy consumption of the charge operation and have greater heat dispersion required to protect the battery increasing energy efficiency and duration thereof.

9. Synergistic system between battery charger and battery according to claim 1, whose twelve pulse frequency multiplying system is characterised in that it is provided with a nine-coil three-phase transformer with flow dispersed by partial overlapping of layers, a double full-wave three-phase rectifier bridge and an interphone reactance which has the purpose of levelling the currents that circulate on the rectifier bridges in such a way to reduce the operation temperature and filter the current supplied by the battery charger in such a way to render it perfectly direct.

10. Synergistic system between battery charger and battery according to claim 1, whose static power factor correction system with capacitors is characterised by a three-phase static power factor correction bank connected on the primary of the fixed capacity transformer and by capacitors which can be three or multiples of three and they can be star-connected or triangle-connected.

11. Synergistic system between battery charger and battery according to claim 1, whose pulse end-of-charge system is characterised by a double input contactor which allows varying the transformation ratio of the transformer by automatically adjusting the end-of-charge current pulses, the pause time of each pulse and the total number of pulses to be used on the technical parameters of the battery being charged transmitted by the microprocessor.

12. Synergistic system between battery charger and battery according to claim 1, characterised in that in order to adapt the charge curve to the operation parameters of the battery, the battery charger may operate on two different power levels identifiable as low power and high power, using the low power at the beginning of the charge and until the battery reaches a preset voltage value, after which the charging proceeds using high power pulses interrupted by pauses that are interrupted by the battery charger depending on the parameters read by the microprocessor, also including the possibility to interrupt the pulses to protect the battery in case excessive temperatures are reached.
